(19) United States
(12) Patent Application Publication
(10) Pub. No.: US 2003/0033919 A1
(43) Pub. Date: Feb. 20, 2003

(54) Venetian blind cutting machine having a plurality of interchangeable tools of various specifications

(75) Inventors: Jung-Kuei Lin, Hsinchu (TW); Ya-Wei Hsu, Hsinchu (TW); Kuei-Lu Liu, Hsinchu Hsien (TW)

Correspondence Address: BROWDY AND NEIMARK, P.L.L.C., 624 Ninth Street, N.W., Washington, DC, 20001-5303, US

(73) Assignee: Industrial Technology Research Institute, Hsinchu Hsien (TW)

(21) Appl. No.: 09/929,002

(22) Filed: Aug. 15, 2001

(51) Int. Cl. B26D 1/00

(52) U.S. Cl. 83/198; 83/454; 83/471.1; 29/24.5

(57) ABSTRACT

A machine for cutting the Venetian blind comprises a base on which a movable seat is mounted. The movable seat is provided with at least two fixed tools for locating the Venetian blind. The movable seat is driven by a tool driving device to displace, so as to locate a predetermined tool at the working position. A cutter driving device drives a cutter to advance to execute the operation of cutting the Venetian blind.

### FIELD OF THE INVENTION

The present invention relates generally to a Venetian blind cutting machine, and more particularly to a Venetian blind cutting machine which is provided with a plurality of interchangeable tools of various specifications to facilitate the cutting of Venetian blinds of various specifications.

### BACKGROUND OF THE INVENTION

The Venetian blind makers generally produce a specific form of Venetian blind in such a way that headrails, bottom rails and slats of a few length specifications are made. These component parts are then cut by the retailer or interior decorator by using a Venetian blind cutting machine. The conventional cutting machines are generally provided with a circular saw or cutter. The U.S. Pat. Nos. 5,799,557, 5,927,172, and 6,089,302 disclose respectively a Venetian blind cutting machine comprising a fixed tool for holding and cutting the component parts of the Venetian blind. The fixed tool is driven by motor or hydraulic cylinder and is provided with a cutter having a specific form for cutting the component parts in a specific manner that the component parts may have an arcuate or inverted fringe. The prior art cutting machines are provided with replaceable tools for cutting the component parts of Venetian blinds of various specifications. However, the tools must be replaced to facilitate the cutting of the Venetian blind of a different specification. It is conceivably inconvenient and time-consuming to mount and dismount a specific tool on the cutting machine. In other words, the Venetian blind cutting machines of the prior art are inefficient.

### SUMMARY OF THE INVENTION

The primary objective of the present invention is to provide a Venetian blind cutting machine with a plurality of tools which are of various specifications and can be interchanged to facilitate the cutting of Venetian blinds of various specifications.

In keeping with the principle of the present invention, the foregoing objective of the present invention is attained by the Venetian blind cutting machine, which comprises a base on which a movable seat is mounted. The movable seat is provided with at least two tools capable of fixing Venetian blind. The movable seat is driven to displace by a tool changing drive device so as to enable a predetermined tool to move to a working position where the Venetian blind is located. A cutter driving device is activated to drive a cutter to execute the cutting operation of the Venetian blind.

### BRIEF DESCRIPTION OF THE DRAWINGS

FIG. 1 shows a front sectional view of a preferred embodiment of the present invention.

FIG. 2 shows a top view of the preferred embodiment of the present invention.

FIG. 3 shows a plan view along the direction indicated by a line 3-3 as shown in FIG. 1.

FIG. 4 shows a sectional view taken along the direction indicated by a line 4-4 as shown in FIG. 3.

FIG. 5 shows a sectional view taken along the direction indicated by a line 5-5 as shown in FIG. 2.

FIGS. 6 and 7 are similar to FIG. 5 for showing the schematic views of the tool changing drive device in action.

### DETAILED DESCRIPTION OF THE INVENTION

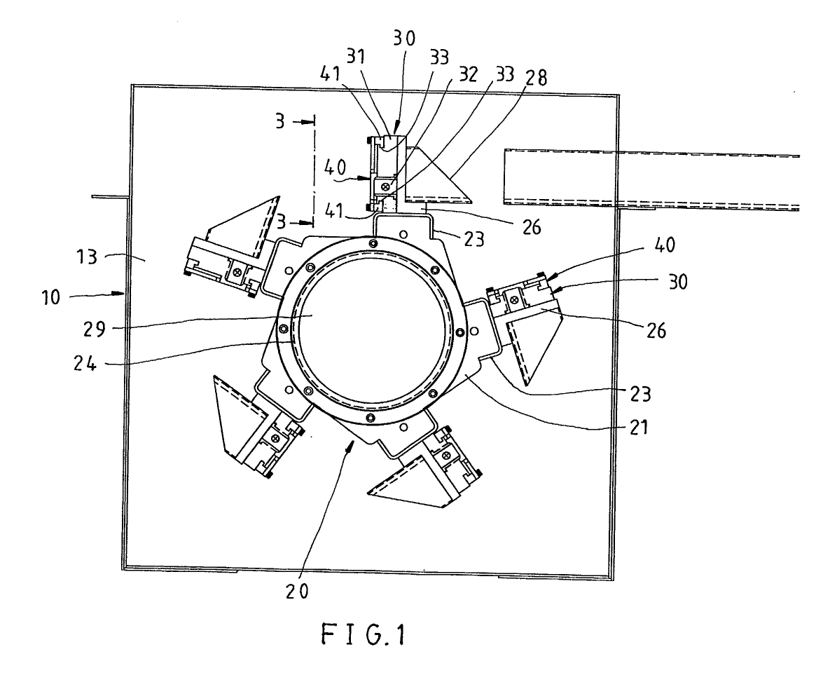

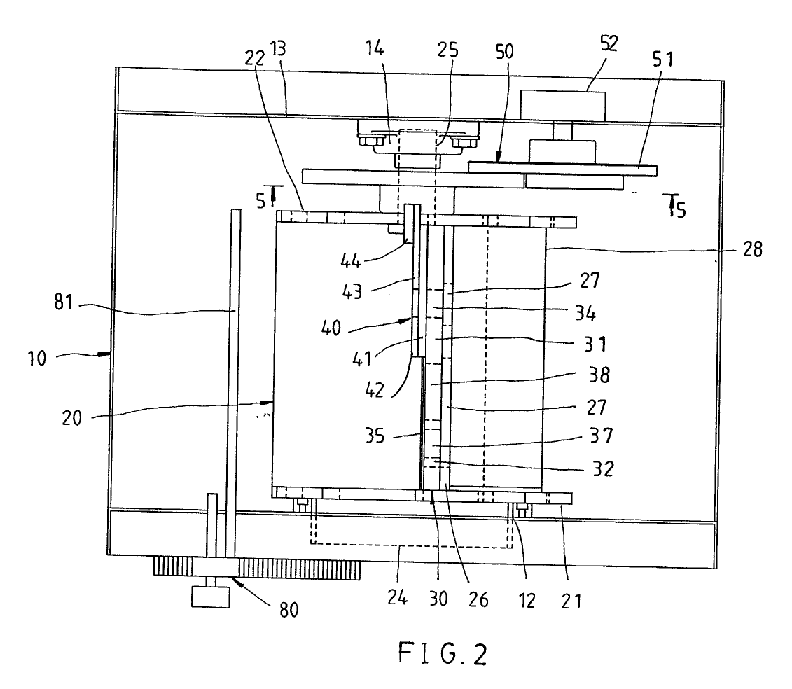

As shown in FIGS. 1 and 2, a Venetian blind cutting machine of the preferred embodiment of the present invention comprises the component parts which are described hereinafter.

A base 10 is a rectangular frame box, which is rested securely on the ground and is provided with a hollowed top. The base 10 is further provided in the center of a front side wall plate 11 with a round pivoting hole 12, and in the inner side of a rear side wall plate 13 with a bearing 14 fastened therewith such that the bearing 14 is coaxial with the pivoting hole 12.

A movable seat 20 is contained in the base 10 and is formed of two side plates 21 and 22 parallel to each other, five long connection plates 23 which are horizontally connected with the two side plates, and a hollow interior formed and defined by the plates, as shown in FIG. 2. The front side plate 21 is provided with a protruded annular cylinder 24 which is inserted into the pivoting hole 12 of the front side of the base 10. The rear side plate 22 is provided with a shaft rod 25 extending therefrom such that the shaft rod 25 is inserted into the bearing 14 of the rear side of the base 10. The movable seat 20 is capable of rotation in the base 10. The two side plates 21 and 22 are pentagonal in shape. The cross section of the connection plates 23 is of an inverted U-shaped construction. These five connection plates 23 are respectively fastened with five sides of the side plates 21 and 22 such that the connection plates 23 are equiangularly disposed on the circumference of the movable seat 20. Each connection plate 23 is provided in the outer side with an auxiliary block 26 having an L-shaped cross section. The shorter side of the auxiliary block 26 is fastened with the connection plate 23 such that the long side of the auxiliary block 26 is perpendicular to the connection plate 23 and is provided with two through holes 27, as shown in FIG. 2. The curved side of the auxiliary block 26 is provided with a support tray 28 of a U-shaped construction. As the movable seat 20 is turned, the support tray 28 does not collide with the base 10. The front side plate 21 of the movable seat 20 is provided with a round through hole 29 corresponding in location to the annular cylinder 24. The hollow interior of the movable seat 20 is in communication with the outside of the base 10 via the through hole 29.

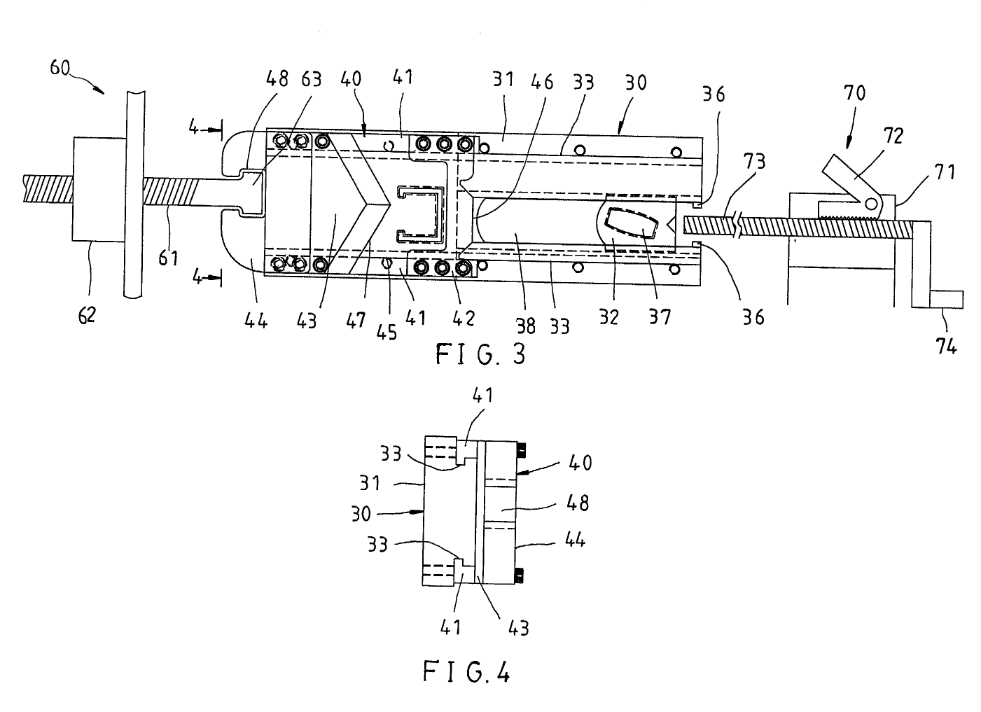

Five fixed tools 30 are respectively fixed on the five connection plates 23 of the movable seat 23. As shown in FIGS. 3 and 4, each tool 30 is formed of a main block 31 and a slide block 32. The main block 31 is rectangular and is rested against the connection plates 23 such that one side of the main block 31 is fastened with the auxiliary block 26, and that other side of the main block 31 is provided with two horizontal slide rails 33 parallel to each other. The main block 31 is provided with an upper rail disposing hole 34 penetrating through the two sides to be in alignment with one of the through hole 27 of the auxiliary block 26. The main block 31 is provided with a slide slot 35 extending from the front end toward the rear end of the main block 31 and having a T-shaped cross section, with the wide end being corresponding to one side of the auxiliary block 26. The front end of the slide slot is provided with two stop portions 36. The slide block 32 has a cross sectional shape matching the slide slot 35 into which it is slidably inserted. The slide block 32 has a lower rail disposing hole 37 penetrating two sides. The rear end of the slide block 32 and the inner end of the slide slot 35 are provided therebetween with a blade disposing hole 38. As the slide block 32 slides, the horizontal width of the blade disposing hole 38 is changed accordingly. The lower rail disposing hole 37 and the blade disposing hole 38 are in alignment with another through hole 27 of the auxiliary block 26. The fixed tools 30 are used to hold securely the Venetian blinds of various specifications. FIG. 3 shows only one set of the fixed tools, with the remainer being similar in construction to the one set as shown in FIG. 3. However, the disposing holes 34, 37, and 38 are different in shape.

Five cutters 40 are respectively mounted on the sides of the five fixed tools 30. As shown in FIGS. 3 and 4, each cutter 40 is formed of two insertion strips 41, a first cutter plate 42, a second cutter plate 43, and a joining block 44. The two insertion strips 41 are inserted into the two slide rails 33 of the tool 30. The two cutter plates 42 and 43 are fastened by bolts with the front and the rear ends of the two insertion strips 41 such that the two cutter plates 42 and 43 are provided therebetween with a hollowed window 45. The first cutter plate 42 is provided with a first blade 46, whereas the second cutter plate 43 is provided with a second blade 47. The joining block 44 is fastened with the second cutter plate 43 and is provided with a T-shaped joining slot 48. As shown in FIG. 3, when the cutters 40 are located at an initial position, the hollowed window 45 is in alignment with the upper rail disposing hole 34 of the tool 30. The second blade 47 is located behind the upper rail disposing hole 34. The first blade 46 is located between the blade disposing hole 38 and the upper rail disposing hole 34. The joining slot 48 extends beyond the rear edge of the auxiliary block 26. The cutters 40 move forward to locate at an end position at which the first blade 46 extends horizontally over the blade disposing hole 38 and the lower rail disposing hole 37. The second blade 47 extends horizontally over the upper rail disposing hole 34. The cutters 40 are designed in conjunction with the fixed tools 30 for cutting the Venetian blinds of various specifications. As a result, the cutters 40 are different from one another in size and shape.

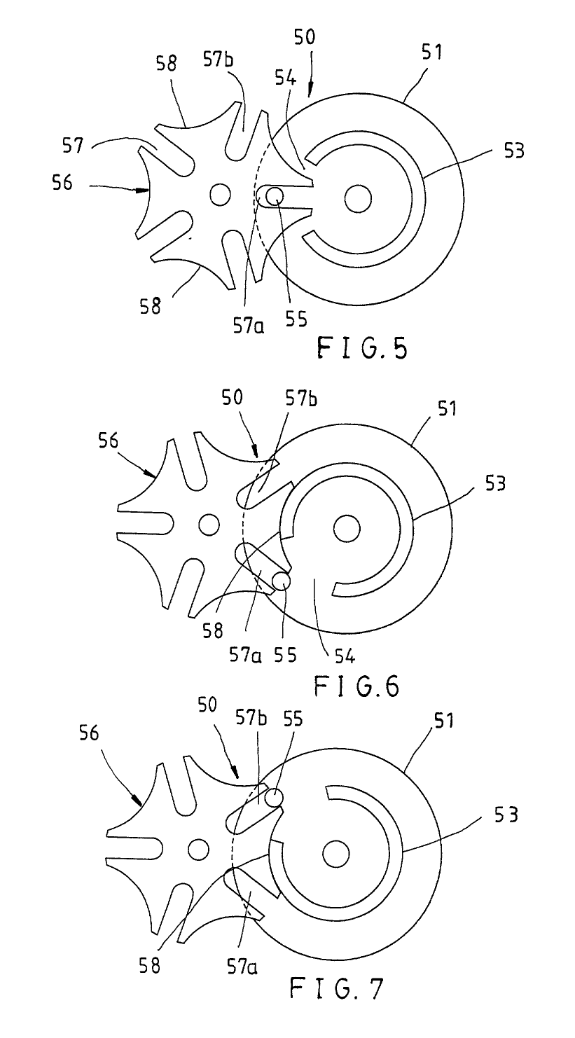

A drive device 50 for changing tools is intended to drive the movable seat 20 to turn so as to locate at a predetermined angular position. As shown in FIG. 5, the preferred embodiment of the present invention makes use of an index plate comprising a moving disk 51 which is pivoted to the inner side of the rear side wall plate 13 of the base 10 and is located beside the axis of the movable seat 20. The base 10 is provided in the outer side with a power set 52 for driving the moving disk 51 to turn. The power set is formed of motor, transmission gears, etc. The moving disk 51 is provided with a C-shaped ring 53 coaxial with the axis, and a protruded shaft 55 corresponding in location to the cut 54 of the protruded ring 53. An intermittent wheel 56 is mounted on the shaft rod 25 behind the movable seat 20 and is provided equiangularly with five radial slots 57, with two adjoining radial slots 57 being provided therebetween with an arcuate slot 58 engageable with the protruded ring 53 of the moving disk 51. The action of the above mechanism is described hereinafter.

Assuming that the intermittent wheel 56 of FIG. 5 is located at a reference angle position such that one radial slot 57a is located horizontally, with its opening facing rightwards. In the meantime, the protruded shaft 55 of the moving disk 51 is located in the horizontal radial slot 57a. The front end of the intermittent wheel 56 is partially extended into the C-shaped protruded ring 53 via the cut 54. When the moving disk 51 is driven to turn counterclockwise, as shown in FIGS. 5 and 6, the intermittent wheel 56 is pushed by the protruded shaft 55 to deflect clockwise until such time when the protruded shaft 55 turns out of the horizontal radial slot 57a, as shown in FIG. 6. The radial slot 57a turns to face rightwards. The next slot 57b deflects to face the opposite side such that its opening is located at the track of the protruded shaft 55. In the course of the moving disk 51 being turned from the position of FIG. 6 to the position of FIG. 7, the intermittent wheel 56 is not affected. After being in the position of FIG. 7, the protruded shaft 55 enters the long slot 57b to begin pushing the intermittent wheel 56 to deflect. Assuming that the moving disk 51 completes one revolution, the intermittent wheel 56 deflects to the long slot 57b in which the protruded shaft 55 is retained, as shown in FIG. 5. In other words, when the moving disk 51 completes one revolution, the intermittent wheel 56 is forced to complete one fifth of one revolution, thereby controlling the movable seat 20 to turn in plate with 72 degree being a unit, so as to locate at one of the five angle positions. The tools 30 of the present invention are not confined to be five in number. The tools 30 must be designed in number in conjunction with the index plate, so as to enable the movable seat 20 to deflect, with 90 degree or 60 degree being the unit. As shown in FIG. 1, when the movable seat 20 is located at an angle position, one of the connection plates 23 is located at the highest point. The fixed tool 30 and the cutter 40 mounted on the connection plate 23 are vertically extended out of the top of the base 10 to locate at the working position. The support tray 28 extends rightwards and horizontally.

A drive device 60 for driving the cutter comprises a pushing member 61 which is a threaded rod, as shown in FIG. 3. The pushing member 61 is disposed on the top of the rear side wall 13 of the base 10 such that its horizontal height is corresponding to the cutter 40 which is located at the working position. The base 10 is provided with a transmission set 62 comprising a motor, and a gear meshing with the threaded rod. The transmission set 62 drives the pushing member 61 to turn to move back and forth horizontally. The pushing member 61 is provided with a T-shaped insertion block 63. When the pushing member 61 is located at the initial position, the insertion block 63 is located in the T-shaped joining slot 48 of the rear end of the cutter 40. As the movable seat 20 turns, each cutter 40 passes the pushing member 61 by means of the joining slot 48. When the movable seat 20 is located to assign a cutter 40 to locate at the working position, the insertion block 63 of the pushing member 61 is inserted into the joining slot 48 of the cutter 40 in question. As the pushing member 61 is moved forward, the cutter 40 in question is advanced to locate at the position at which the cutting is done. Thereafter, the cutter 40 is withdrawn to locate at the initial position.

A press device 70 is disposed in the top of the front side of the base 10 and is corresponding in location to the fixed tool 30 at the working position. The press device 70 is a prior art structure and is formed of a base 71 on which a threaded member 72 is pivoted such that the threaded member 72 deflects back and forth. Located under the threaded member 72 is a thread rod 73 which penetrates the base 71 and is provided at the front end with a rocking handle 74 fastened therewith such that the rear end of the threaded rod 73 can reach the front end surface of the slide block 32 of the tool 30. If the threaded member 72 is moved rearwards and upwards, the operator can directly hold the threaded rod 73 to advance and withdraw rapidly. If the threaded member 72 is moved forward, the threaded rod 73 can be slightly advanced or withdrawn by turning the rocking handle 74.

A flush device 80 is mounted on the top of the front side of the base 10 and is located at the left side of the press device 70. The flush device 80 is a prior art structure and is provided with an adjustable stop rule 81 which can be turn to locate horizontally at a predetermined distance from the fixed tool 30 at the working position. The stop rule 81 can be turned to locate uprightly without obstructing the movable seat 20.

In operation, the fixed fool 30 and the cutter 40 are mounted on the movable seat 20 before the movable seat 20 is driven by the tool changing drive device 50 to deflect a predetermined angle, thereby locating the fixed tool 30 and the cutter 40 at the working position (standby position). The headrail, the slats and the bottom rail of the Venetian blind are arranged on the support tray 28 such that they are put through the through holes 27 of the L-shaped auxiliary block 26 as well as the headrail disposing hole 34, the slat disposing hole 38 and the bottom rail disposing hole 37 of the fixed tool 30. In addition, the headrail is put through the hollowed window 45 of the cutter 40. In light of the headrail disposing hole 34 and the bottom rail disposing hole 37 being corresponding in cross-sectional shape to the headrail and the bottom rail of the Venetian blind, the headrail and the bottom rail are securely located. The slats are different in number and thickness. For this reason, the slats are held securely together by the slide block 32 of the tool 30, which is pushed by the threaded rod 73 of the press device 70. The flush arrangement of the Venetian blind is attained by adjusting the stop rule 81 of the flush device 80 to locate at the left side of the tool 30. The cutter 40 is driven by the cutter driving device 60 to advance from the initial position to execute the cutting operation such that the slats and the bottom rail are cut by the first blade 46 of the cutter 40, and that the headrail is cut by the second blade 47 of the cutter 40. The removed parts are collected in the hollow interior of the movable seat 20 and are then disposed of via the through hole 29 of the movable seat 20 in conjunction with a disposal means (not shown in the drawings).

The present invention can be electrically operated to speed up the cutting operation. In addition, the present invention is provided with a plurality of tools and cutters of various specifications for cutting the Venetian blinds of various specifications, without the time-consuming chores of mounting and dismounting the tools and the cutters. The present invention is therefore relatively more efficient than the prior art structures.

The movable seat 20 of the present invention is moved in the form of a rotational displacement. The fixed tools and the cutters are equiangularly arranged along the circumference. However, the movable seat may be designed to displace vertically in conjunction with the tools which are longitudinally arranged. Moreover, the movable seats may be designed in such a manner that they displace horizontally, whereas the tools are horizontally arranged. Each tool of the present invention is provided with a cutter, which may be mounted on an output end of the cutter driving device for cutting the Venetian blinds of various forms.

What is claimed is:

1. A machine for cutting Venetian blinds of various specifications, said machine comprising:
a base;
a movable seat movably mounted on said base;
at least two fixed tools mounted on said movable seat and provided with a plurality of disposing holes for locating the headrail, the slats and the bottom rail of a Venetian blind;
a tool driving device for driving said movable seat to displace such that a predetermined fixed tool is displaced to locate at a working position to execute the operation of cutting the Venetian blind;
at least one cutter capable of displacing along the direction in which the headrail, the slats and the bottom rail of the Venetian blind are arranged; and
a cutter driving device for driving the cutter to displace to execute the operation of cutting the Venetian blind.

2. The machine as defined in claim 1, wherein said movable seat is pivoted to said base; wherein said tool driving device drives said movable seat to rotate so as to locate as a predetermined angle position.

3. The machine as defined in claim 2, wherein said fixed tools are arranged equiangularly and circularly on said movable seat; wherein said tool driving device drives said movable seat to deflect at a unit of a predetermined angle.

4. The machine as defined in claim 3, wherein said tool driving device comprises a pushing disk pivoted to said base and provided with a C-shaped protruded ring coaxial with the axis, and a protruded shaft corresponding in location to a cut of said protruded ring, said tool driving device further comprising a power set for driving said pushing disk to rotate, and an intermittent wheel mounted on said movable seat such that said intermittent wheel is coaxial with the axis of said movable seat and is provided with a plurality of radial long slots corresponding in number to said fixed tools, said long slots being arranged equiangularly such that two adjoining long slots are provided therebetween with an arcuate slot engageable with said protruded ring of said pushing disk.

5. The machine as defined in claim 1, wherein said fixed tools are provided with said cutter which has a joining hole; wherein said cutter driving device has a pushing member capable of being driven to displace in a direction parallel to a direction in which the headrail, the slats, and the bottom rail of the Venetian blind are arranged, said cutter driving device having a joining block corresponding in shape to said joining hole of said cutter and capable of being inserted into said joining hole of said cutter in the working position.

6. The machine as defined in claim 5, wherein said cutter is provided at the front end with a first blade for cutting the slats and the bottom rail of the Venetian blind, said cutter provided in the center with a hollowed window for receiving therethrough the headrail of the Venetian blind, said hollowed window provided in the rear end with a second blade for cutting the headrail of the Venetian blind.

7. The machine as defined in claim 1, wherein said fixed tool has a headrail disposing hole, a slat disposing hole, and a bottom rail disposing hole for locating respectively the headrail, the slats, and the bottom rail of the Venetian blind.

8. The machine as defined in claim 7, wherein said fixed tool is formed of a main block and a slide block, said main block having said headrail disposing hole and provided with a slide slot in which said slide block is slidably disposed, said slide block having said bottom rail disposing hole, said slide block having an inner end which is provided along with an inner end of said slide slot with said slat disposing hole located therebetween.

9. The machine as defined in claim 8, further comprising a press device disposed on said base and provided with an adjustable threaded rod which has one end capable of pressing against the outer end surface of said slide block of said fixed tool.

10. The machine as defined in claim 6, wherein said fixed tool has a headrail disposing hole, a slat disposing hole, and a bottom rail disposing hole for locating respectively the headrail, the slats, and the bottom rail of the Venetian blind.

11. The machine as defined in claim 10, wherein said fixed tool is formed of a main block and a slide block, said main block having said headrail disposing hole and provided with a slide slot in which said slide block is slidably disposed, said slide block having said bottom rail disposing hole, said slide block having an inner end which is provided along with an inner end of said slide slot with said slat disposing hole located therebetween.

12. The machine as defined in claim 11, further comprising a press device disposed on said base and provided with an adjustable threaded rod which has one end capable of pressing against the outer end surface of said slide block of said fixed tool.

13. The machine as defined in claim 2, wherein said base has a box shape with a hollowed top; wherein said movable seat is contained in the interior of said base such that the axial line thereof is horizontally located, and that said movable seat is located at a highest point at the time when one of said fixed tools is located at the working position, and that the Venetian blind is horizontally put through said tool, with the headrail, the slats and the bottom rail being horizontally arranged.

14. The machine as defined in claim 13, wherein said movable seat is provided at two axial ends with two side plates parallel to each other, and a plurality of long connection plates connecting at an interval said two side plates, said movable seat being of a hollow frame; wherein said base has a round pivoting hole, one of said side plates of said movable seat provided with an annular cylinder which is inserted into said pivoting hole, said side plate provided with a through hole corresponding to the interior of said annular cylinder; a disposal means being jutted out of said base via said through hole from the interior of said movable seat.
